(19) United States
(12) Patent Application Publication
(10) Pub. No.: US 2011/0163553 A1
(43) Pub. Date: Jul. 7, 2011

(54) MULTIPOINT LOCK EXTENSION FOR A ROUND TOP DOOR

(75) Inventor: Paul D. Fleming, Glendale, CA (US)

(73) Assignee: W & F MANUFACTURING, INC., Glendale, CA (US)

(21) Appl. No.: 12/983,631

(22) Filed: Jan. 3, 2011

Related U.S. Application Data
(60) Provisional application No. 61/291,982, filed on Jan. 4, 2010.

(51) Int. Cl. E05C 1/10

(52) U.S. Cl. 292/42

(57) ABSTRACT

A latch and lock extension is provided for a round top door, for use in combination with a multipoint latch and lock mechanism of the type disclosed in U.S. Pat. No. 5,290,077. The extension comprises a curved channel for guiding an elongated auxiliary actuator drive bar along a curved path from one side edge of the door where it is coupled with a main drive bar as disclosed in U.S. Pat. No. 5,290,077, to at least one auxiliary latch cartridge disposed generally at the top of the round top door for engaging an associated keeper in the top of the door frame. The auxiliary actuator drive bar is constructed from an assembled plurality of articulating links and a plurality of relatively rigid bridge links to accommodate the size and curved shape of the curved channel.

### BACKGROUND OF THE INVENTION

This invention relates generally to improvements in door latch and related latch bolt operators for releasibly latching and/or locking a door, such as a residential or commercial entry door, with multiple latch bolts. More specifically, this invention relates to an extension for use with a multipoint latch bolt system of the type disclosed in U.S. Pat. No. 5,290,077, wherein the extension accommodates secure closure of a door having a curved or irregular top shape, such as a round top door.

Door latch and lock assemblies for use with hinged swinging doors are generally known in the art, and typically include at least one movable lock member mounted at a selected vertical position along a free side edge of the door in proximity with an actuator positioned for convenient manual access and operation. For example, in a hinged or swinging door, a spring-loaded latch bolt is normally mounted on the door at a mid-height position to engage a strike or keeper plate mounted on the adjacent door jamb, to retain the door in a normal closed position. A rotary handle or lever is commonly included as part of the latch and lock assembly, and is adapted for manual rotation to retract the latch bolt from the strike plate and thereby permit the door to be opened. These lock assemblies further include at least one lock device which may be designed to preclude latch bolt retraction in the locked condition, and/or may comprise a separate dead bolt for use in selectively locking the door.

Although such conventional door latch and lock assemblies as described above have generally performed their latching and/or locking functions in a satisfactory manner, there has been an on-going desire and need for further improvements in entry door security for residences and business establishments, particularly with respect to withstanding high winds loads such as gale-force or hurricane-force winds. Toward this end, so-called multipoint lock assemblies have been developed wherein multiple lock members such as multiple retractable latch bolts are provided at vertically spaced positions along the free side edge of a traditional or generally rectangular-shaped door for engaging a corresponding number of strike plates mounted at corresponding positions on the adjacent door jamb. In some designs, the multiple lock members are adapted for independent actuation, with the unfortunate result that frequently only one of the lock members is engaged due to human forgetfulness and/or neglect. In other designs, the multiple lock members are adapted for concurrent actuation by means of a single operator handle or lever.

U.S. Pat. No. 5,290,077 discloses an exemplary multipoint door lock assembly including multiple retractable latch bolts mounted at vertically spaced positions along the free side edge of an entry door or the like. A primary latch bolt is positioned generally at a mid-height location in close proximity with an actuator mechanism. A pair of secondary latch bolts are respectively positioned vertically above and below the primary latch bolt, and are linked by slide-mounted extension rods with the actuator mechanism. A lever handle or the like at an outboard side of the door is manually grasped and rotated to operate the actuator mechanism to retract all three latch bolts in a concurrent manner. When the rotary lever handle is released, one or more springs incorporated into the actuator mechanism causes the latch bolts (and lever handle) to return automatically to a normal extended position. As is known in the art, each latch bolt normally includes one tapered face to accommodate automatic retraction as the latch bolt engages the associated strike plate during door closure movement, followed by automatic re-extension of the latch bolt into a strike plate keeper recess as the door reaches the closed position.

However, a multipoint latch system of the type shown in U.S. Pat. No. 5,290,077 has not been designed for use with modern entry doors of a non-standard type or shape having a curved or irregular-shaped top, such as a round top door. Such curved or round top doors can undesirably flex at the curved upper ends thereof to result in undesired door opening in response to a high wind load, despite the presence of a multipoint latch system mounted along a free side edge of the door.

There exists, therefore, a need for further improvements in and to multipoint door latch mechanisms particularly of the type adapted for concurrently retracting multiple latch bolts in a multipoint system of the shown and described in U.S. Pat. No. 5,290,077, wherein the door latch mechanism includes an extension fitted into a curved or round top door to provide at least one addition latch bolt positioned generally at the top of the door, but wherein this additional latch bolt is retracted in unison with other system latch bolts to permit easy door opening, when desired. The present invention fulfills these needs and provides further related advantages.

### SUMMARY OF THE INVENTION

In accordance with the invention, a latch and lock extension is provided for a round top door, for use in combination with a multipoint latch and lock mechanism of the type disclosed in U.S. Pat. No. 5,290,077. The extension includes at least one auxiliary latch cartridge having an associated auxiliary latch bolt disposed generally at the curved top of the door for operation in unison with multiple latch cartridges mounted along a vertically extending free side edge of the door, in accordance with the multipoint latch mechanism disclosed in U.S. Pat. No. 5,290,077, which is incorporated by reference herein. In an extended position, the auxiliary latch bolt engages a keeper in the top of an associated door frame for securely retaining the door in a closed position.

In one preferred embodiment of the invention, the extension comprises a curved channel for guiding an elongated auxiliary actuator drive bar along a curved path from the free side edge of the door to the at least one auxiliary latch cartridge disposed generally at the top of the curved or round top door. The auxiliary actuator drive bar is constructed from an assembled plurality of articulating links and a plurality of relatively rigid bridge links to accommodate the specific size and curved shape of the curved channel. A lower end of the auxiliary actuator drive bar is adapted for quick and easy connection to an upper end of a main drive bar forming a portion of the multipoint latch mechanism as disclosed in U.S. Pat. No. 5,290,077.

In operation, manipulation of the multipoint latch mechanism of U.S. Pat. No. 5,290,077 is effective to manually withdraw all of the latch bolts, including the auxiliary latch bolt, in unison from their respective keepers to permit door opening. Upon release, each latch bolt including the auxiliary latch bolt is desirably spring-loaded for automatic return to an advanced position. Thus, when the door is closed, each latch bolt is automatically extended into latching engagement with the associated keeper mounted on or in the associated door frame for securely retaining the door in the closed position.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is an outboard side plan view of a round top door in a closed position, equipped with a multipoint latch assembly of the type shown and described in U.S. Pat. No. 5,290,077, and further including an extension constructed in accordance with the present invention and having an auxiliary latch cartridge disposed generally at the top of the round top door;

FIG. 2 is an exploded perspective view showing the round top door from an inboard side, with the multipoint point latch assembly of U.S. Pat. No. 5,290,077, and further including the round top extension in accordance with the present invention;

FIG. 3 is an enlarged sectional view showing the extension with components thereof in assembled relation;

FIG. 4 is an enlarged and exploded perspective view of the extension from an outboard side thereof;

FIG. 5 is a vertical plan view of the extension, taken generally on the line 5-5 of FIG. 3;

FIG. 6 is a horizontal top plan view of the extension, taken generally on the line 6-6 of FIG. 3;

FIG. 7 is a horizontal bottom plan view of the extension, taken generally on the line 7-7 of FIG. 3;

FIG. 8 is a fragmented plan view taken generally on the line 8-8 of FIG. 3;

FIG. 9 is a fragmented sectional view taken generally on the line 9-9 of FIG. 8;

FIG. 10 is an enlarged and fragmented sectional view corresponding generally with the encircled region 10-10 of FIG. 3;

FIG. 11 is a fragmented sectional view taken generally on the line 11-11 of FIG. 10;

FIG. 12 is a developed underside plan view of the extension, corresponding generally with FIG. 7; and

FIG. 13 is an enlarged and fragmented sectional view corresponding generally with the encircled region 13-13 of FIG. 3.

### DETAILED DESCRIPTION OF THE PREFERRED EMBODIMENTS

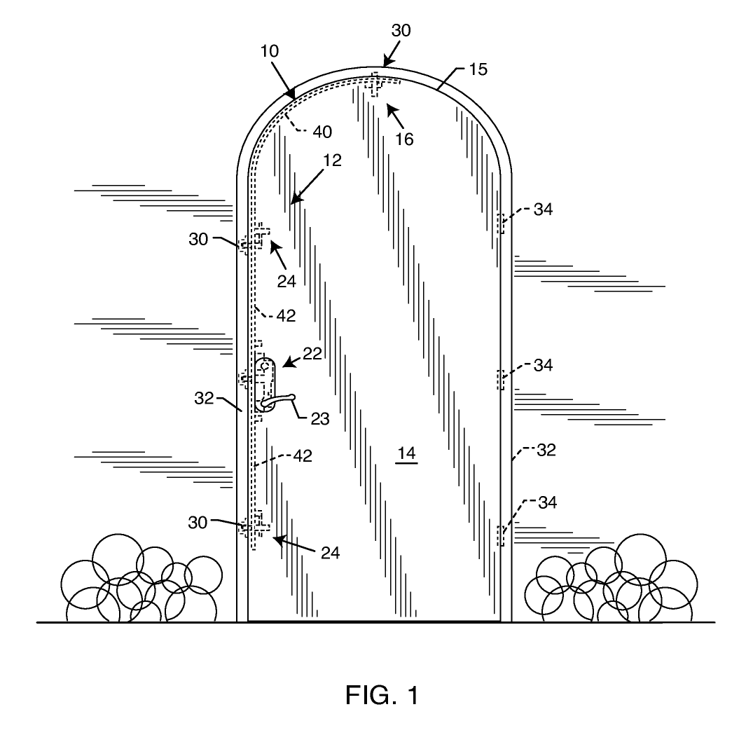

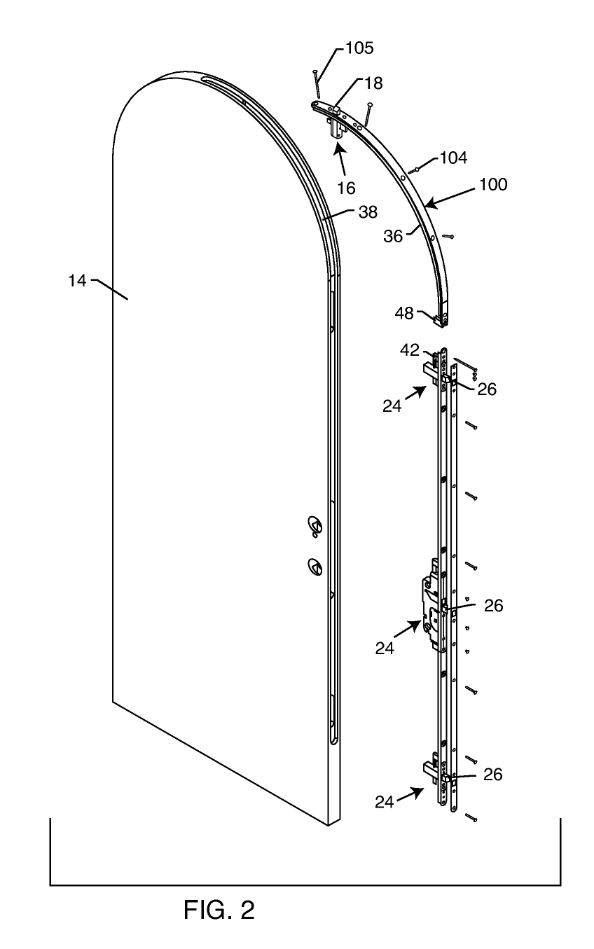

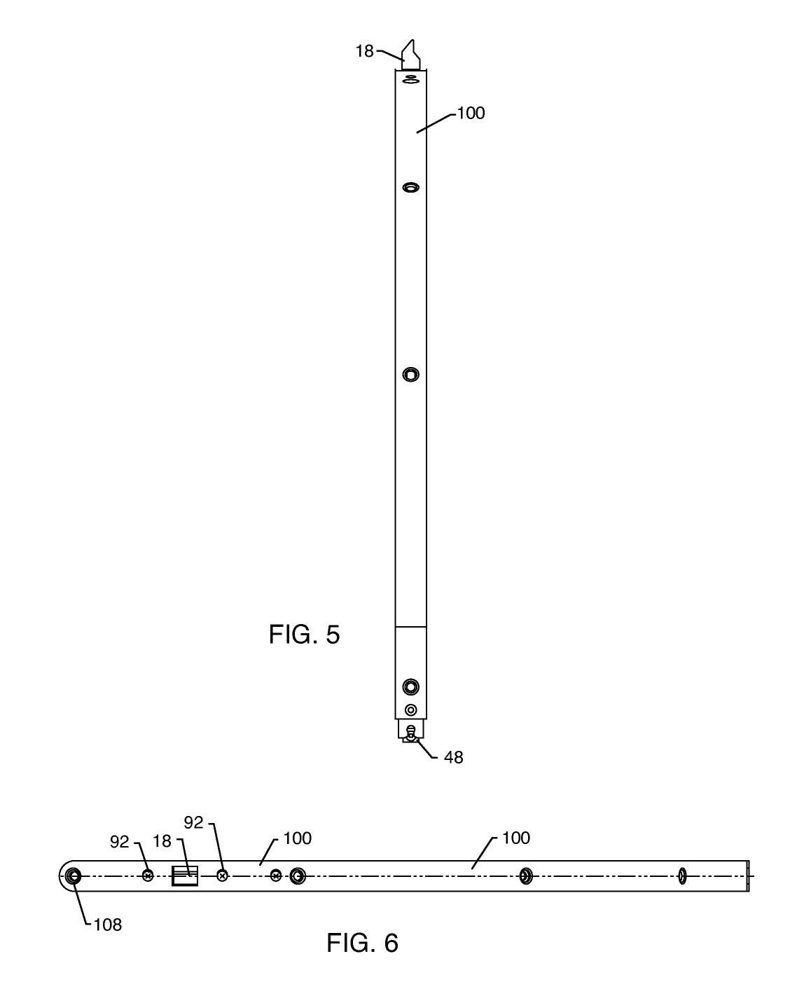

As shown in the exemplary drawings, a curved extension referred to generally by the reference numeral 10 in FIGS. 1-7 is provided for use in combination with a multipoint latch mechanism 12 (FIGS. 1-2) to provide enhanced and secure closure of a door 14 of the type having an irregular or curved upper end 15, such as a round top door 14 shown in FIGS. 1-2. The curved extension 10 includes at least one auxiliary latch cartridge 16 having an auxiliary latch bolt 18 (FIG. 2) positioned generally at the top of the door 14 for releasibly engaging an associated keeper 20 (FIG. 1) to assist in retaining the door 14 is the closed position. In this regard, the multipoint latch mechanism 12 includes a latch operator 22 having a door handle 23 (FIG. 1) and multiple latch cartridges 24 each including an associated latch bolt 26 (FIG. 2) as shown and described in U.S. Pat. No. 5,290,077, which is incorporated by reference herein. The extension 10 of the present invention accommodates actuation of the auxiliary latch bolt 18 in unison with the multiple latch bolts 26 by means of the operator 22 to permit door opening.

As shown best in FIGS. 1 and 2, the door 14 includes a curved upper end such as a round top shape. The multipoint latch mechanism 12 of U.S. Pat. No. 5,290,077 includes the multiple latch cartridges 24 disposed at vertically spaced positions along a free side edge 28 of the door 14, wherein each latch cartridge 24 includes one of the latch bolts 26 extensible into latched engagement with an associated keeper 30 (FIG. 1) mounted on or within the associated door jamb 32. An opposite vertical side edge of the door 14 is coupled to the associated door jamb as by means of multiple, vertically spaced hinges 34. As shown and described in U.S. Pat. No. 5,290,077, this multipoint latch mechanism 12 beneficially provides enhanced door security together with an enhanced ability to retain the door in a securely closed condition in response to high wind loads, such as gale-force or hurricane-force winds. However, this enhanced door security is limited to a conventional, generally rectangular door shape of the type shown in U.S. Pat. No. 5,290,077.

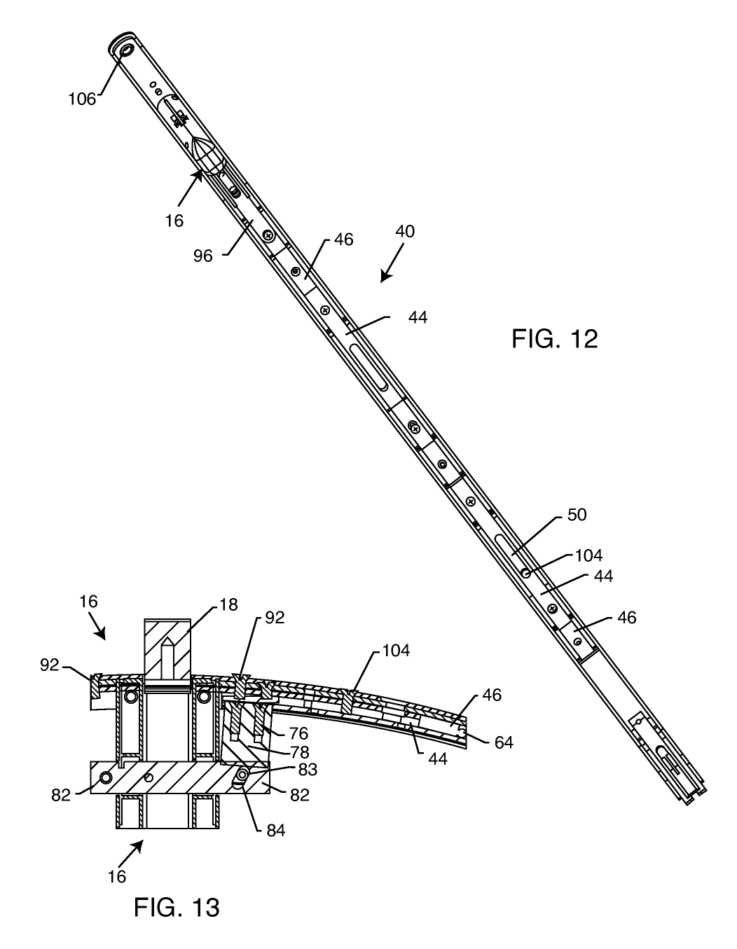

The extension 10 of the present invention accommodates secure door retention in the closed position for modern door configurations including a non-linear, irregular or curved top, such as the round top door shape shown in FIGS. 1-2. In general, the extension 10 comprises a curved channel member 36 having a size and shape for nested reception into a matingly shaped slot or recess 38 (FIG. 2) formed in a portion of the rounded or curved door top. An auxiliary actuator drive bar 40 (shown best in FIG. 12) is fitted within this curved channel 36 and is adapted for quick and easy coupling between an upper end of a main drive bar 42 (FIG. 2) of the multipoint latch mechanism 12, and the auxiliary latch cartridge 16 disposed generally at the top of the door. Importantly, this auxiliary actuator drive bar 40 is constructed from a combination of relative rigid bridge links 44 interconnected by flexible or articulating links 46 to provide the desired length which tracks within the associated curved channel member 36. In operation, the latch bolt 18 of the auxiliary latch cartridge 16 is manually retracted in unison with the multiple latch bolts 26 of the main latch cartridges 24 of the multipoint latch mechanism 12.

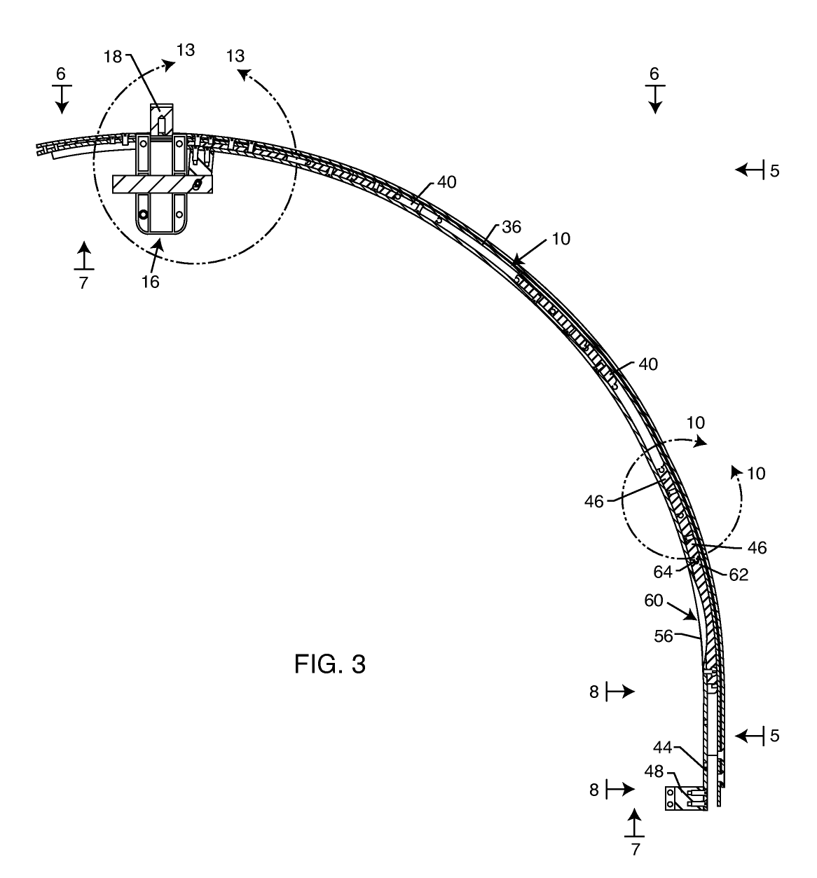

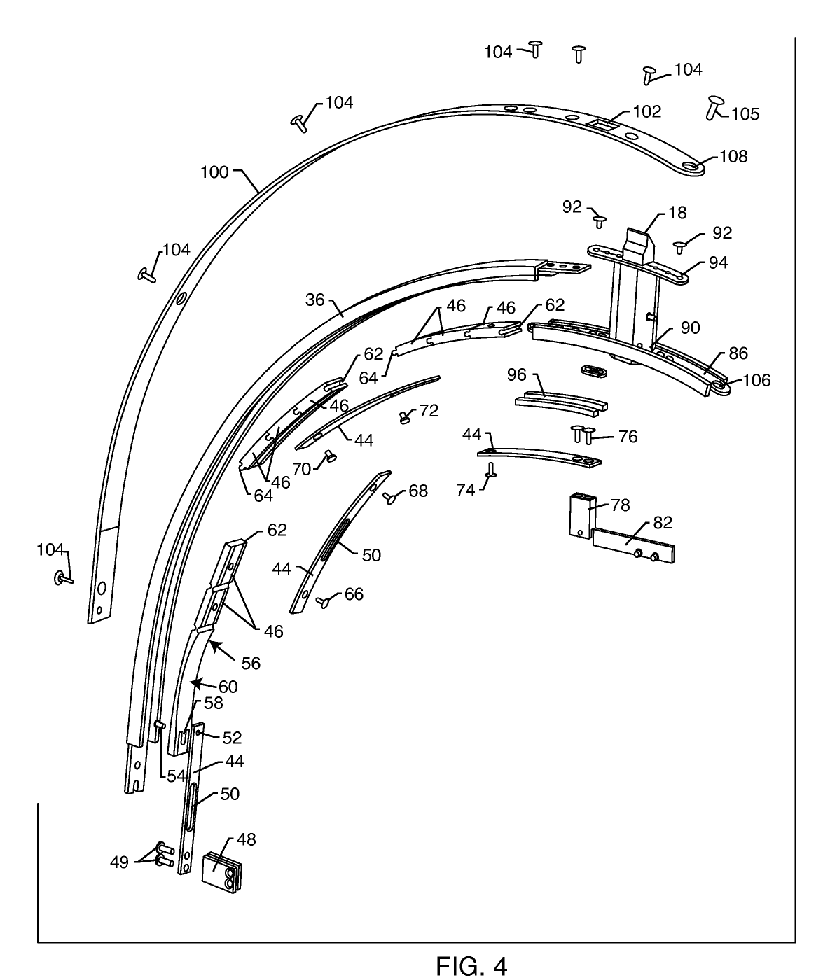

FIGS. 3-13 show preferred construction details of the curved extension 10. As shown, a lower end of the auxiliary actuator drive bar 40 carries a tab-shaped connector 48 for suitable connection as by means of a pair of small screws or the like (not shown) to an upper end of the main drive bar 42 of the multipoint latch mechanism 12. This connector 48 is carried in turn at the lower end of an elongated and relatively rigid bridge link 44 (FIG. 4) as by means of another pair of small screws 49. As shown, this first bridge link 44 corresponds conveniently in construction with other bridge links used in the system (as will be described), to include an elongated central slot 50 and small port 52 near an upper end thereof for attachment to additional components of the auxiliary actuator drive bar 40.

More specifically, the upper end of the first bridge link 44 is coupled as by means of a small screw 54 to a lower end of a flexible adjustment link 56 constructed from a low friction material such as a molded plastic material, and preferably such as an acetyl polymer. This adjustment link 56 has a relatively short but nevertheless elongated slot 58 formed therein for passage of the screw 54 into threaded engagement with and attachment to the upper end of the first bridge link 44. This slot 58 accommodates minor or fine-tuned length adjustment of the entire auxiliary actuator drive bar 40.

The adjustment link 56 extends upwardly from the slotted coupling with the first bridge link 44, and includes a central region 60 which has a reduced thickness to permit curved flexing in a manner to accommodate the specific curved shape of the channel 36, while continuing to exhibit substantial longitudinal stiffness. This reduced thickness central region 60 merges at an upper end of the adjustment link 56 with a laterally extending rounded groove 62.

The rounded groove 62 at the upper end of the adjustment link 56 rotatably receives a matingly shaped rounded tongue 64 formed in a lower end of an adjacent articulating link 46, which in turn has another rounded groove 62 formed at an upper end thereof. This upper rounded groove 62 in turn receives, as viewed in the illustrative embodiment depicted in FIG. 4, another matingly shaped rounded tongue 64 at the lower end of a second, identical articulating link 46.

The second articulating link 46 (FIG. 4) is fastened in turn by a small screw 66 or the like to a lower end of a second bridge link 44. This second bridge link 44 is coupled in turn by a small screw 68 or the like to the lowermost end of a trio of rotatably interconnected articulating links 46, the uppermost end of which is connected in turn by a small screw 70 or the like to another rigid bridge link 44. As shown, this latter bridge link 44 is fastened in turn to the lowermost end of another trio of rotatably interconnected articulating links 46 by means of another small screw 72 or the like, with an uppermost end of these articulating links 46 being coupled by a small screw 74 or the like to a final bridge link 44.

The final bridge link 44 is connected by a pair of screws 76 or the like to a tab-shaped connector 78. The thus-assembled auxiliary actuator drive bar 40 can be slidably installed into the curved channel 36 and exhibits sufficient longitudinal stiffness for movement reciprocally back and forth within the curved channel 36, in response to longitudinal displacement of the main drive bar 42 (FIGS. 1-2) to open and close the door 14. In this regard, the curved channel 36 is conveniently constructed from a stiff or rigid material such as a metal extrusion to fit or nest snugly within the curved recess 38 (FIG. 2) formed in a portion of the top 15 of the door 14. As shown best in FIG. 11, the channel 36 has a generally U-shaped configuration opening radially inwardly, with short fingers 80 protruding from the inboard-extending legs a short distance toward each other to effectively retain the drive bar 40 within the U-shaped channel 36.

The tab-shaped connector 78 at the uppermost end of the auxiliary actuator drive bar 40 extends radially inwardly from the drive bar 40 for connection in turn with an actuator link 82 of the auxiliary latch cartridge 16. Such connection is achieved, as shown in FIG. 13, by means of an axle pin 83 carried by the connector 78 in engagement within a cam slot 84 defined near one end of the actuator link 82. This axle pin 83 thereby transmits linear motion of the auxiliary actuator drive bar 40 to the actuator link 82 for operating the auxiliary latch cartridge 16 to withdraw the associated auxiliary latch bolt 18 in unison with the main latch bolts 26 to permit door opening, in response to manual actuation of the door operator 22 as by means of manual rotation of the door handle 23 (FIG. 1). As in known in the art, spring means (not shown) associated with the door operator 22 and/or with each latch cartridge 16, 24 will automatically return each latch bolt 18, 26 to the advanced position upon handle release. In this regard, persons skilled in the art will appreciate that the auxiliary latch cartridge 16 is constructed according to the latch cartridges 24 of the multipoint latch mechanism 12, all as shown and described in U.S. Pat. No. 5,290,077, which is incorporated by reference herein. In particular, the auxiliary latch cartridge includes the latch bolt 18 with a tapered face to accommodate automatic retraction as the latch bolt engages the associated strike plate during door closure movement, followed by automatic re-extension of the latch bolt into the associated strike plate keeper 30 as the door reaches the closed position

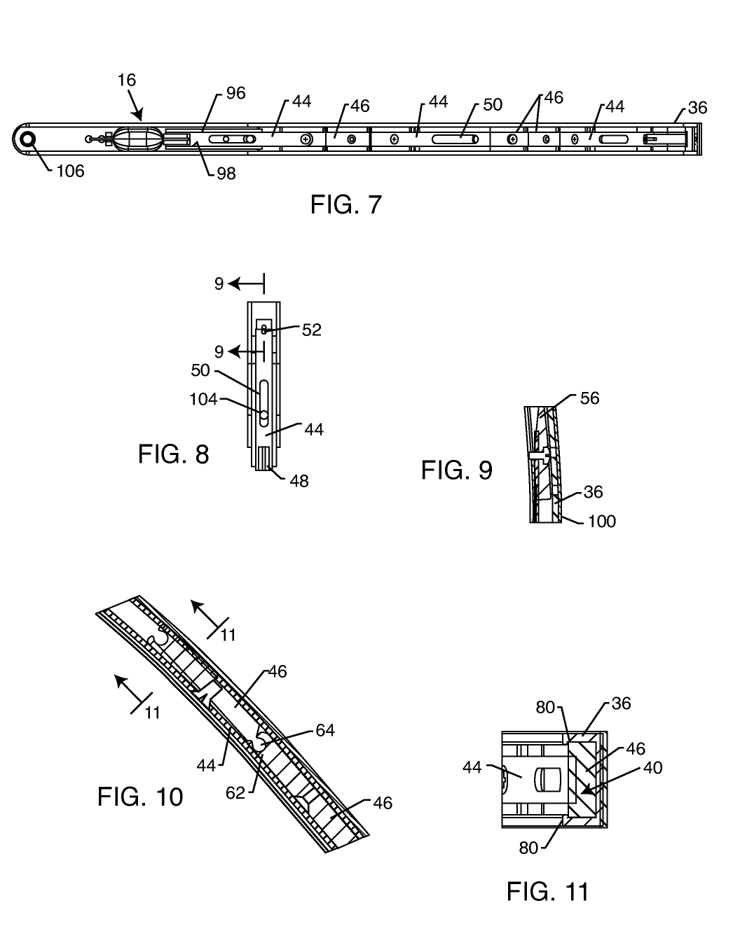

As shown in FIG. 4, the auxiliary latch cartridge 16 is conveniently and securely mounted within a channel adapter 86 coupled to the end of the channel 36 by means of one or more screws. This channel adapter 86 has a central opening 90 formed therein for convenient mounting of the auxiliary latch cartridge 16, with the latch bolt 18 thereof protruding normally in a radially outward direction for engagement with the associated keeper 20 (FIG. 1). Screws 92 or the like are provided for securely attaching a faceplate flange 94 of the latch cartridge 16 to the channel adapter 86. A guide link 96 is secured at an inboard side of the channel adapter 86 as by means of small screws, and defines a small track 98 (FIG. 7) for slidably guiding the uppermost bridge link 44 through the desired reciprocal movement to retract and advance the latch bolt 18.

The entire channel 36 and associated channel adapter 86 are conveniently concealed within the door recess 38 by a faceplate strip 100. This faceplate strip 100 extends from a lowermost end aligned with and/or joined to an upper end of a similar faceplate strip (FIG. 2) of the multipoint attachment mechanism 12, to an uppermost end having a central aperture 102 through which the latch bolt 18 extends. Multiple screws 104 or the like are provided for securing the faceplate strip 100 to the door 14, wherein these screws 104 conveniently extend through the elongated central slots 50 in the bridge links 44 for fastening into the door edge. An uppermost screw 105 extends through aligned apertures 106 and 108 formed respective in the channel adapter 86 and the faceplate strip 100 for direct fastening into the door edge.

A variety of further modifications and improvements in and to the door latch extension 10 of the present invention will be apparent to those persons skilled in the art. Accordingly, no limitation on the invention is intended by way of the foregoing description and accompanying drawings, except at set forth in the appended claims.

What is claimed is:

1. An extension for use in combination with a door lock assembly including a multipoint latch and lock mechanism mounted along a free side edge of a hinged door, and having a main drive bar operated by a main latch operator including a door handle, said extension comprising:
an auxiliary actuator drive bar;
means for coupling a lower end of said auxiliary actuator drive bar generally to an upper end of the main drive bar; and
at least one auxiliary latch cartridge connected to said auxiliary actuator drive bar at a position spaced from said lower end;
said auxiliary actuator drive bar including an assembled plurality of articulating links and relatively rigid bridge links, said auxiliary actuator drive bar being adapted for extending along a non-linear upper portion of a door for engaging a keeper mounted in the top of the door frame.

2. The extension of claim 1 wherein said auxiliary actuator drive bar is seated within a curved channel formed in an edge of the door and extending between the free side edge and a top portion of the door.

3. The extension of claim 2 wherein the door has a round top.

4. The extension of claim 1 wherein said auxiliary actuator drive bar comprises a group of said articulating links interconnected in series with each other, each of said groups of said interconnected articulating links being coupled alternately with said bridge links.

5. The extension of claim 4 wherein said articulating links each comprise a relatively stiff component having a rounded tongue at one end and a rounded groove at an opposite end.

6. The extension of claim 4 wherein each of said groups of said interconnected articulating links is coupled by fastener means to at least one of said bridge links.

7. The extension of claim 1 wherein said means for coupling auxiliary actuator drive bar to the main drive bar comprises an adjustment link having an elongated adjustment slot formed therein, said adjustment link further including a central portion of reduced thickness to accommodate curved flexing with substantial longitudinal stiffness.

8. The extension of claim 7 wherein said adjustment link is formed from a relatively low friction plastic material.

9. The extension of claim 1 wherein said at least one latch cartridge include a latch bolt movable between a retracted position to accommodate door closure, and an advanced position for engaging the keeper strike plate.

10. The extension of claim 9 wherein the main latch operator includes spring means for biasing said latch bolt normally to said advanced position.

11. An extension for use in combination with a door lock assembly including a multipoint latch and lock mechanism mounted along a free side edge of a hinged door, and having a main drive bar operated by a main latch operator including a door handle, said extension comprising:
an auxiliary actuator drive bar including at least one group of articulating links interconnected in series with each other, and coupled at at least one end thereof with a relatively stiff bridge link;
means for coupling a lower end of said auxiliary actuator drive bar generally to an upper end of the main drive bar; and
at least one auxiliary latch cartridge connected to said auxiliary actuator drive bar at a position spaced from said lower end;
said auxiliary actuator drive bar being adapted for extending along a non-linear upper portion of a door for engaging a keeper mounted in the top of the door frame.

12. The extension of claim 11 wherein said auxiliary actuator drive bar is seated within a curved channel formed in an edge of the door and extending between the free side edge and a top portion of the door.

13. The extension of claim 12 wherein the door has a round top.

14. The extension of claim 11 wherein each of said group of said articulating links comprises a relatively stiff component having a rounded tongue at one end and a rounded groove at an opposite end.

15. The extension of claim 11 wherein each of said groups of said interconnected articulating links is coupled by fastener means to at least one of said bridge links.

16. The extension of claim 11 wherein said means for coupling auxiliary actuator drive bar to the main drive bar comprises an adjustment link having an elongated adjustment slot formed therein, said adjustment link further including a central portion of reduced thickness to accommodate curved flexing with substantial longitudinal stiffness.

17. The extension of claim 16 wherein said adjustment link is formed from a relatively low friction plastic material.

18. The extension of claim 11 wherein said at least one latch cartridge include a latch bolt movable between a retracted position to accommodate door closure, and an advanced position for engaging the keeper strike plate.

19. The extension of claim 18 wherein the main latch operator includes spring means for biasing said latch bolt normally to said advanced position.
